(19) United States
(12) Patent Application Publication
(10) Pub. No.: US 2022/0092138 A1
(43) Pub. Date: Mar. 24, 2022

(54) SYSTEM AND METHOD FOR DELIVERING INFORMATION TO A USER

(71) Applicant: Cameron Price, Coogee (AU)

(72) Inventor: Cameron Price, Coogee (AU)

(21) Appl. No.: 17/274,563

(22) PCT Filed: Sep. 3, 2019
(86) PCT No.: PCT/AU2019/050932

§ 371 Date: Mar. 9, 2021

(30) Foreign Application Priority Data
Sep. 16, 2018 (AU) 2018903485

(51) Int. Cl. G06F 16/9535; G06Q 30/02; H04L 67/50

(52) U.S. Cl. CPC G06F 16/9535; G06Q 30/0282; H04L 67/22; G06Q 30/0269; G06Q 30/0203

(57) ABSTRACT

A method and system (1) for delivering tailored information to a user based on an updatable user profile. The system includes an information database (2), a user device (3) and a processor (4). The information database (2) includes a plurality of categorised information items (5). The user device (3) includes a user interface (7). The processor (4) generates an information feed (6), by selecting one or more information items (5) from said information database (2), each information item (5) being selected based on its categorised relevance to a user profile. The processor (4) then outputs said information feed (6) to the user interface (7) of said user device (3), receives a user feedback score (8) of each information item (5), via said user interface (7) and updates said user profile based on said user feedback score(s) (8).

### TECHNICAL FIELD

The present invention relates to a system and method for delivering personalised information to a user, and more specifically, to a system and method which delivers tailored information to a user based on the individual interest of the user.

In particular, the present invention relates to a system and method which generates an information feed which is tailored to the particular interests of a user, and, which may typically include news items and/or advertisements which are fed to a user's device. User feedback is provided to the system/method in response to the information items, to then update the user's profile. The updated user profile thereafter tailors the subsequent information feed to the user device.

### BACKGROUND ART

Any reference herein to known prior art does not, unless the contrary indication appears, constitute an admission that such prior art is commonly known by those skilled in the art to which the invention relates, at the priority date of this application.

The development of information technology and the internet has provided many changes and improvements to the provision of information from providers to consumers, and vice versa. However, the sheer volume of information delivered to consumers has presented a formidable problem to consumers.

For example, in relation to general everyday news, people typically expend considerable amounts of time reviewing multiple news articles to identify information on specific topics in which they have an interest. Traditional information providers such as the television and multimedia news industry still provide news content in a broadcast approach where the news is delivered to the user primarily based on their location. Users may typically have more personalization with web sites, Smart TV's and Smart App's, but such applications still generally only deliver information based on location, publication date and news relevance to the overall demographic.

The advertising industry is increasingly favouring digital advertising over traditional media, as digital advertising provides consumers with a one-to-one marketing approach in which consumers are presented with an option to immediately purchase products. This industry is always looking for ways to improve the targeting of advertising material towards appropriate customers who may have an interest in the product/services they are marketing.

Furthermore, polling data is currently typically produced from telephone interviews or random surveys, where the sample size is often limited to a small percentage of the population, in which the accuracy of polling on specific subjects is low. Generally, in order to provide valid polling data across a large region, the method would require a census, which could prove slow, difficult and costly.

### SUMMARY OF THE INVENTION

The present invention seeks to address these various problems of the prior art, by providing a system and method in which information may be conveyed to and from a user in a more personalised manner.

The present invention also seeks to address these various prior art problems by providing a system and method in which information may be conveyed according to the particular interests of the person.

The present invention also seeks to address the problems of the prior art by providing a system and method for delivering tailored information to a user based on their individual user profile, and in which this profile may be updated to take into account the changing interests etc.

In one broad form, the present invention provides a system for delivering tailored information to a user based on an updatable user profile, the system including:
an information database, including a plurality of categorised information items;
a user device, including a user interface; and,
a processor, to:
   generate an information feed, by selecting one or more information items from said information database, each information item being selected based on its categorised relevance to a user profile;
   output said information feed to the user interface of said user device; receive a user feedback score of each information item, via said user interface; and,
   update said user profile based on said user feedback score(s).

Preferably, the information items includes news bulletins, advertisements, educational seminars, television or radio programs, movies or any other text, audio and/or video information items which may be categorised and be of varying interest levels to individual users.

Preferably, each information item is categorised into at least one category by a manual or automated process, optionally using machine learning or using artificial intelligence.

Preferably, each information item is categorised into at least one news category, including, but not limited to sports, politics, entertainment, breaking news, finance, technology, consumer, finance, crime, law & order, gossip, fashion, local news, international news, natural disasters, etc.

Preferably, the user device includes a smartphone, smart TV, computer, PDA or any other multimedia computing platform device.

Preferably, said user interface, includes any one or combination of a display screen, a touch screen, a keyboard, voice activated microphone, or any other interface device capable of receiving user input and output data.

Preferably, said user interface includes a user input interface device to provide a plurality of user selectable options including any one or combination of:
a numerical or like score selection buttons displayed on said user device, for example, to select a score of 1 to 10;
a drop down table of categories, for example, to select a user interest category; and,
a touch screen for a user to swipe in one of a plurality of directions, for example left, right, up and down indicative of a user interest level.

Preferably, said user interface includes a user monitoring interface device to detect a user interaction with the user device including any one or combination of:
a facial recognition device to detect the presence of a user looking at the user interface;
a timing device to detect how long a user has an information item displayed on said user interface; and,
a counting device to detect the number of times a user views a particular information item, a particular category of news items, etc. and,
a habit monitoring device to monitor the viewing habits of a user, including but not limited to the frequency of user interaction, the times of user interaction, the periods of user interaction, etc.

Preferably, said user profile is updated according to an algorithm or the like, based on any one or combination of:
a user feedback score provided by a user via said user interface; and,
a user feedback score calculated by the user monitoring device detecting the user interaction with the user device.

In a further broad form, the present invention provides a method of delivering tailored information to a user based on an updatable user profile, the method including the steps of:
generating an information feed, by selecting one or more information items from an information database, each information item being selected based on its categorised relevance to a user profile;
outputting said information feed to a user interface of a user device;
receiving a user feedback score of each information item, via a user interface of said user device; and,
updating said user profile based on said user feedback score(s).

Preferably, the information items includes news bulletins, advertisements, educational seminars, television or radio programs, movies or any other text, audio and/or video information items which may be categorised and be of varying interest levels to individual users.

Preferably, each information item is categorised into at least one category by a manual or automated process, optionally using machine learning or using artificial intelligence.

Preferably, each information item is categorised into at least one news category, including, but not limited to sports, politics, entertainment, breaking news, finance, technology, consumer, finance, crime, law & order, gossip, fashion, local news, international news, natural disasters, etc.

Preferably, the user device includes a smartphone, smart TV, computer, PDA or any other multimedia computing platform device.

Preferably, said user interface, includes any one or combination of a display screen, a touch screen, a keyboard, voice activated microphone, or any other interface device capable of receiving user input and output data.

Preferably, said user interface includes a user input interface device to provide a plurality of user selectable options including any one or combination of:
a numerical or like score selection buttons displayed on said user device, for example, to select a score of 1 to 10;
a drop down table of categories, for example, to select a user interest category; and,
a touch screen for a user to swipe in one of a plurality of directions, for example left, right, up and down indicative of a user interest level.

Preferably, said user interface includes a user monitoring interface device to detect a user interaction with the user device including any one or combination of:
a facial recognition device to detect the presence of a user looking at the user interface;
a timing device to detect how long a user has an information item displayed on said user interface; and,
a counting device to detect the number of times a user views a particular information item, a particular category of news items, etc. and,
a habit monitoring device to monitor the viewing habits of a user, including but not limited to the frequency of user interaction, the times of user interaction, the periods of user interaction, etc.

Preferably, said user profile is updated according to an algorithm or the like, based on any one or combination of:
a user feedback score provided by a user via said user interface; and,
a user feedback score calculated by the user monitoring device detecting the user interaction with the user device.

In a further broad form, the present invention provides a user device for a user to receive selected information items from a plurality of categorised information items stored in an information database based on an updatable user profile of the user, the user device including:
a user output interface, for a user to receive each information item;
a user input interface, for a user to input a user feedback score for each said information item;
wherein, each said feedback score is communicated to a processor to update said user profile.

In a further broad form, the present invention provides an information database including a plurality of categorised information items which are adapted to be individually selected to generate an information feed and outputted to provide tailored information to a user device based on their categorised relevance to an updatable user profile.

In a further broad form, the present invention provides a processor to:
generate an information feed, by selecting one or more information items from an information database, each information item being selected based on its categorised relevance to a user profile;
output said information feed to a user output interface of a user device;
receive a user feedback score of each information item, by said user inputting said feedback score via a user input interface; and,
update said user profile based on said user feedback score.

Preferably, each information item is categorised using machine learning or artificial intelligence algorithms.

In a further broad form, a computer program product having computer-executable code for categorising information items for storage in an information database, wherein at least one information item is then selected to generate an information feed and delivered to a user device based on its relevance to an updatable user profile.

In a further broad form, a computer program application installed on a user device, the application adapted to:
output one or more information item of an information feed via a user output interface on said user device;
receive a user feedback score of each information item via a user input interface on said user device;
communicate said user feedback score to a processor which updates a user profile based on said user feedback score.

In a further broad form, a system for polling or surveying a plurality of users, the system including:
an information database, including a plurality of categorised information items;
a plurality of user devices, each user device including a user interface; and,
a processor, to:
   generate an information feed to each user device, by selecting one or more information items from said information database, each information item being selected based on its categorised relevance to a respective user profile;
   output said information feed including a user survey information request to the user interface of each said user device;
   receive a user feedback score of each information item and a user survey information result, via said user interface;
   update said user profile based on said user feedback score(s); and,
   correlate the user survey information results from each said user device to provide an output survey result.

In a further broad form, a method of polling or surveying a plurality of users, the method including the steps of:
generating an information feed to a plurality of user devices, by selecting one or more information items from said information database, each information item being selected based on its categorised relevance to a respective user profile;
outputting said information feed including a user survey information request to the user interface of each said user device;
receiving a user feedback score of each information item and a user survey information result, via said user interface;
updating said user profile based on said user feedback score(s); and,
correlating the user survey information results from each said user device to provide an output survey result.

### BRIEF DESCRIPTION OF THE DRAWINGS

The present invention will become more easily understood from the following detailed description of preferred but non limiting embodiments thereof, described in connection with the accompanying drawings, wherein:

FIG. 1 illustrates a general overview of a system for delivering tailored information to users, in accordance with a preferred embodiment of the present invention;

FIG. 2 illustrates a flowchart depicting a method of producing an information feed to a user, and, receiving feedback from the user to update their user profile;

FIG. 3 shows an exemplary embodiment of user device interface showing a user questionnaire for a user to input their interest levels in various information items;

FIG. 4 shows an exemplary embodiment of a user device interface showing how a user may swipe to input user response scores after viewing an information item;

FIG. 5 illustrates an information database diagram, showing typical categories of information items and how they may be assigned tags, dates, location, etc. data for classification of the information items, in accordance with a preferred embodiment of the present invention;

FIG. 6 shows an exemplary embodiment of a flowchart of a questionnaire and algorithm diagram which may be implemented in the present invention to identify and modify the interest levels of users in the various database fields;

FIG. 7 illustrates a user reaction diagram showing how a user may typically react in response to viewing an information item, and how the reactions may be analysed;

FIG. 8 shows a flow chart of an exemplary information item presented to a user, in the form of a news item relating to an Olympic 100 m final race, and illustrating typical user reactions;

FIG. 9 shows a flow chart of another exemplary information item presented to a user, in the form of a news item relating to an Australian Federal election news item, showing how the invention may further gather and analyse polling data;

FIG. 10 shows an example of a user device interface, showing the initial display of several information items making up an information feed;

FIG. 11 shows an alternative exemplary embodiment to the user device shown in FIG. 4, being in the form of a TV remote controller, for user to input response scores after viewing an information item;

FIG. 12 illustrates an embodiment of a system illustrating the interconnection between an information database Server and a plurality of user mobile computing devices;

FIG. 13 is a simplified flowchart of the method of the present invention;

FIG. 14 is a flowchart showing a method of analysing user reaction which maybe input via a swiping movement generated by the user, where the magnitude may be varied based on the direction of movement;

FIG. 15 is a flowchart showing a method where the swiping movement by the user can be further varied in magnitude depending on the direction of movement based on using an extra degree of freedom;

FIG. 16 is a flowchart showing a method of analysing the user event input via a plurality of activities generated by the user, where the magnitude is varied based on the duration on news content, percentile of shown news content and frequency of swipes on the news content;

FIG. 17 is a flowchart showing a method of initialising the user's interest level based by using a questionnaire procedure;

FIG. 18 shows a flowchart of a method for the general procedures that the user may typically perform when accessing the news application on a user device; and,

FIG. 19 shows a flowchart showing a method of collecting polling information based on a federal election news story and then delivered to third parties.

### DETAILED DESCRIPTION OF PREFERRED EMBODIMENTS

Throughout this specification, like numerals will be used to identify like features in the drawings, except where expressly otherwise indicated.

Also, throughout this specification, wherever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The present invention provides a system for delivering tailored information to users.

### Overall System

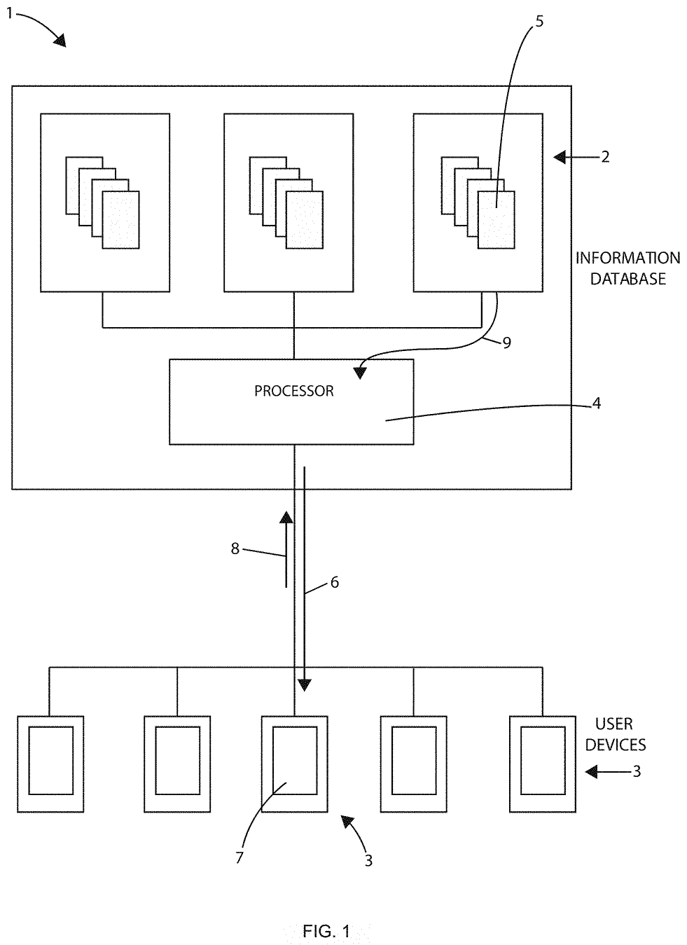

As illustrated in FIG. 1, the information delivery system 1 includes an information database 2, which may include a plurality of categorised information items 5, at least one user device 3, and, a processor 4.

The processor 4 is adapted to generate an information feed 6, made up of a plurality of individual information items 5 which are tailored to the interests of a specific user. The information feed 6 is then fed to a user device 3, based on a user profile which is known and/or learned by the processor 4.

An information feed 6 may be generated by selecting one or more information items 5 from the information database 2. Each information item 5 is selected, based on its categorised relevance to the user profile of a user operating each particular user device 3. For example, as shown in FIG. 1, each information item 5 may be selected by the processor 4, as represented by arrow 9. Other information items are likewise selected from the information database 2 to make up a composite information feed 6, represented by arrow 6. Once an information feed 6 is generated by the processor 4, it is supplied to a specific user device 3.

This information feed 6, after being conveyed to the user device 3, may be viewed by a user on all appropriate interface on the user's device 3. For example, the interface could be a display screen on a smart phone.

It will be appreciated that a wide variety of user devices 3 could be utilised in the present invention. For example, typical user devices 3 may include a smart phone, smart TV, computer, PDA, or any other multimedia computing platform device.

As a user views the information item 5, the user may then input a feedback score, pertinent to each information item, via a user interface 7. This feedback score is conveyed to the processor 4, as represented by arrow 8. The processor 4 then updates the profile of the user, based on the user's feedback score.

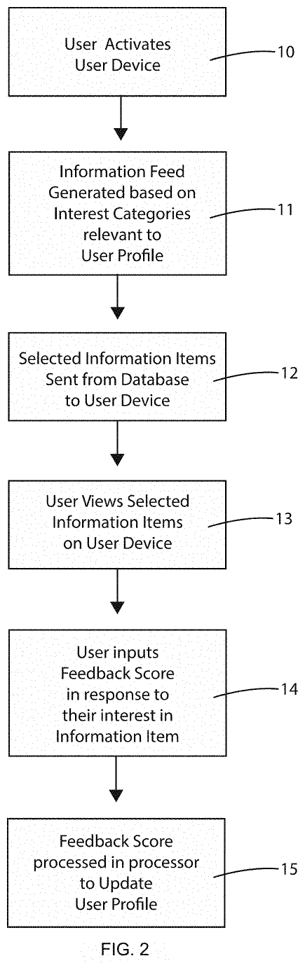

FIG. 2 illustrates a flowchart outlining the main steps in producing an information feed 6 to be provided to a user device 3, and then receive feedback 8 from the user device 3 to thereby update the users profile in the processor 4.

As illustrated in FIG. 2, once a user activates a user device 3, as illustrated in step 10, an information feed 6 is generated. This information feed 6 is based upon interest categories relevant to a user profile, as shown in step 11. The setup of the user profile and the updating of the user profile will be described hereinafter.

The information feed 6 is generated by selecting information items 5 from the information database 2, to, such that these information items 5 are then ultimately fed to the user device 3, as illustrated in step 12 by arrow 9.

Once the user views the selected information items 5 on the user's device 3, as illustrated in step 13, the user is able to input a feedback score in response to their interest in each particular information item 5, as illustrated in step 14. Details as to how the feedback score may be input by the user will be described hereinafter. Once the feedback score is input by the user, it is sent to the processor 4 to update the user profile, as illustrated in step 15.

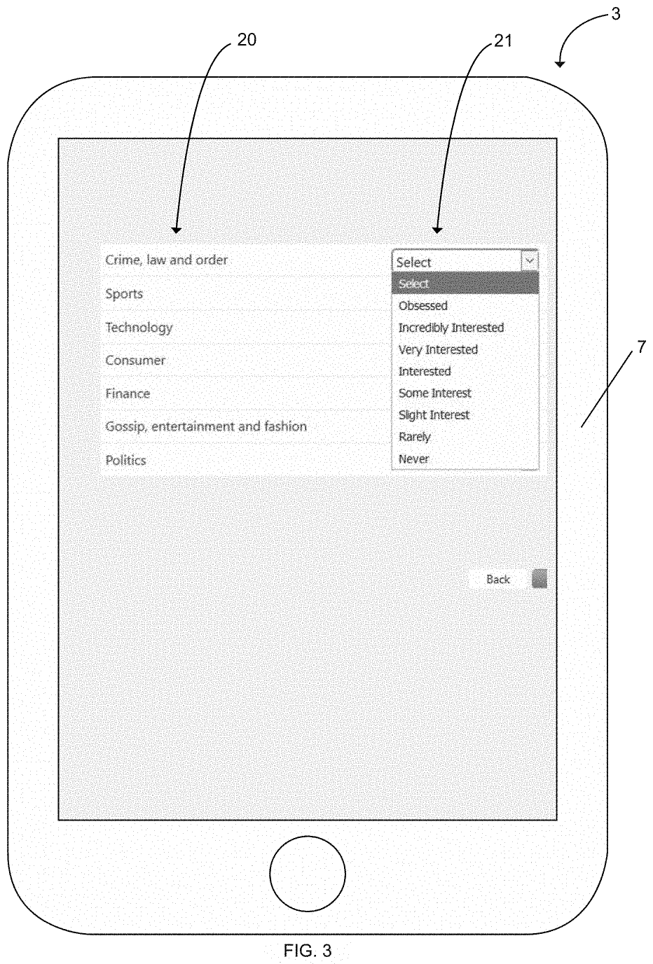

FIG. 3 shows an exemplary embodiment of the user device 3 which incorporates a device interface 7 in the form of a touchscreen on a smart phone.

### User Interest Levels

A wide variety of other user interfaces could be utilised in the present invention. Typical user interfaces may include any one or combination of, a display screen, a touchscreen, a keyboard, a voice activated microphone, or, any other interface device capable of receiving user input and output data.

FIG. 3 shows a user questionnaire displayed on the user device 3, by which a user may initially input their interest levels in various information items. In this exemplary embodiment, the information items may be news items. The information items could however be a wide variety of information items, including, but not limited to, news bulletins, advertisements, educational seminars, television or radio programs, movies or any other text, audio and/or video information items. As will be appreciated, any such information items may typically be categorised, and, be of varying interest levels to individual users.

In the exemplary embodiment, wherein the information items are news items, each news information item maybe then further categorised. For example, news categories could include sports, politics, entertainment, breaking news, finance, technology, consumer, crime, law and order, gossip, fashion, local news, international news, natural disasters, etc.

The categorisation of each information item 5 may be performed either manually or by an automated process.

For example, machine learning or artificial intelligence could be used this categorisation, whereby the occurrence of certain words or certain sequences of words in a news item may facilitate automated recognition of the relevance of the news item to a particular category, and therefore categorise it accordingly. It will be appreciated by person skilled in the art that this categorisation may be performed in a variety of ways, and all such categorisation techniques should be considered to fall within the scope of the invention as herein described.

For each information item, as shown in column 20 of FIG. 3, a user is able to select an interest level option 19, such as shown in column 21. In this particular example, eight interest level options 19 are illustrated. For example, different users may typically have a very varying level of interest in the topic of finance. Some persons have no interest in finance, whilst others are obsessed with financial news, and, others will have a varying level of interest therebetween. As such, an appropriate interest level may be selected according to the particular user's interest.

The illustrated example of FIG. 3 shows the varying interest level options 19 being categorised as follows: never interested, rarely interested, slight interest, some interest, interested, very interested, incredibly interested, and, obsessively interested.

It will be appreciated that a wide variety of other interest levels may be alternatively or additionally included, and the number of interest level options 19 may be also widely varied. For example, in some examples of the present invention, a user might only be given two interest level options 19, i.e. interested, or, not interested. However, in other examples, a user may be given many more interest level options 19 other than the eight levels shown in the FIG. 3 example.

It will be appreciated that when a user initially enrols in the information provision system, or subscribes to a news provision system, such as described the present invention, that they may typically be provided with a questionnaire, such as shown in FIG. 3, to determine their initial levels of interest. This initial set up can be used at the outset to form the basis of the initial user profile, which then determines the selection of the information items 5 which may thereafter be generated to form an information feed 6.

The present invention, however, does not merely thereafter rely on this initial set up of the user interest levels, but rather, allows for the user profile to be updated. This is to take into account, for example, a user's changing interest in varying news or other information items over time, etc.

### User Feedback Input

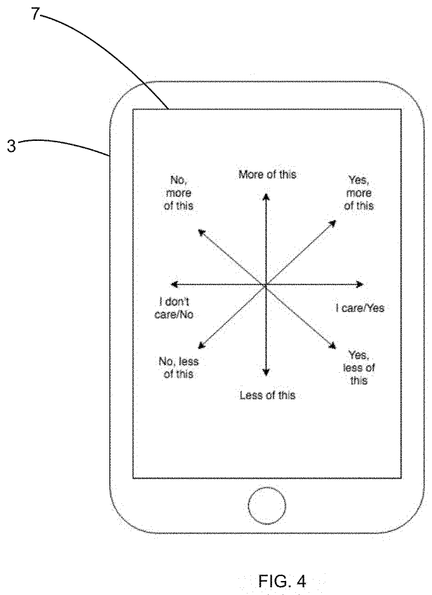

In FIG. 4, it is shown in exemplary embodiment of a user device 3 incorporating a user device interface 7, showing how a user may swipe to enter a feedback score as a user views and information item 5.

It will however be appreciated that a wide variety of user input interface devices 7 could be used for users to be able to select options to provide feedback in the form of a feedback score, or, other feedback indicator. User input interfaces 7, provide a plurality of user selectable options, that may typically include any one or combination of: numerical score selection buttons, a drop-down table of categories, and/or, a touchscreen for a user to swipe in one of a plurality of directions, etc.

The illustrated embodiment of FIG. 4 shows this latter form of user interface 7, that is, a touchscreen for a user to swipe in one of a plurality of directions. As can be seen, a user may swipe left, right, upwards or downwards, as indicated by the arrows in FIG. 4, or, any direction therebetween, to indicate their level of interest. Specifically, in FIG. 4, a user may swipe directly upwards to indicate a high level of interest and that they want to receive more of this type of information item, whilst they might swipe directly downwards if they want less of the type of information item they have just viewed on the screen. Swiping in any direction other than directly up or down may be indicative of a scale the relative level of interest between these maximum and minimum interest levels.

Alternatively, or additionally, the user device may incorporate a user interface 7 which is capable of monitoring or detecting the user's interaction with the user device 3. That is, instead of the user having to proactively input a feedback score, a feedback score may be automatically generated by monitoring of the user and/or their habits.

For example, a facial recognition device could be used to detect the presence of a user viewing the user interface 7. For example, this may be achieved utilising the camera on a smart phone, in the same way that the camera is utilised to allow a particular user to unlock a smartphone device 3.

Alternatively or additionally, a timing device could be utilised to detect how long a user has had an information item displayed on the user interface 7 of their device. This may be indicative of the user reading the information item slowly or carefully, which may typically represent a strong interest of the user in respect of the information item. This could be utilised in conjunction with the facial recognition detector to ensure that the user is actually reading information item, rather than having placed there device 3 aside, whereby the information item is not actually been read by the user at the time.

Alternatively or additionally, a counting device may detect the number of times a user views a particular information item. This re-reading of the information item may typically be indicative of a user having a strong interest in the information article.

Additionally or alternatively, one or more habit monitoring device could monitor the viewing habits of the user. This may include, but should not be limited to, the frequency of user interaction with the device 3, monitoring the user's utilisation of the device of certain periods of the day, for example in the morning, at lunchtime, whilst on the train on the way home from their office, etc. Data from the habit monitoring device may then be utilised to tailor the information feed, such that it is prepared so as to conform to the user habits to provide an information feed 6 which takes into account this users habits. For example, if a user only light to view news items once a day, then, in collating the information feed, information items of importance over the prior 24-hour period could be typically collated together in a single information feed, for the convenience of the user.

Alternatively or additionally, the time periods of user interaction with their device 3, could be monitored. For example, if it is detected that a user only interacts with their device 3 for periods of 2-3 minutes at a time, then tailored information feeds could be provided, limited to that timeframe, so as to suit that particular user's habits.

The processor 4 of the present invention may therefore incorporate a module which updates each users profile according to any one or combination of the aforementioned criteria. These criteria may be collated together to produce an appropriate algorithm which the processor 4 utilises to perform this function and thereby update the user profile. That is, user profile may be updated according to an algorithm which is based on any one or combination of a user feedback score which is specifically provided via a user interface, and/or a user feedback score which is calculated by automatically detecting the user interaction with the device 3.

As generally described hereinbefore, the present invention therefore provides a method of delivering tailored information to a user, which is based on an updatable user profile. The method generally includes the steps of firstly generating an information feed, by selecting one or more information items from an information database, with each information item being selected based on its categorise relevance to a user profile. The information feed which is thereby generated is outputted to a user interface of a user device 3, such that a user can view each information item of the information feed. As each information item is viewed, a feedback score is thereby provided to the processor, according to any one or combination of the user proactively input in a score or this score being automatically generated as hereinbefore described. The processor then updates the user profile based on this user feedback score.

### Exemplary Embodiment

In an exemplary embodiment of the invention, the invention may include two databases linked by an algorithm that works on addition and subtraction within a field of values ranging from 0-100. The linking mechanism may be in the form of an application programming interface. A first database, i.e. a user database, may allow values to be assigned to the various interests of an individual viewer. These values may initially be assigned by responses to an opening questionnaire. The questionnaire may ask a series of questions determining how often a user watches the news, their location, or, a location they are interested in, their interest in a series of news categories including but not limited to Sports, Politics, Entertainment, Breaking News, Finance, Technology, Consumer and Finance.

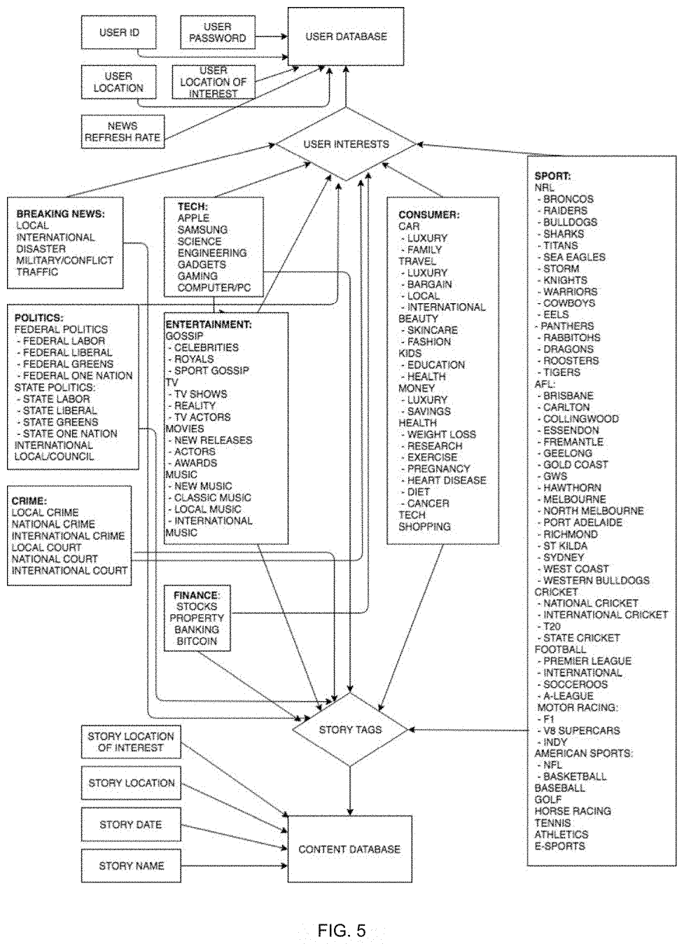

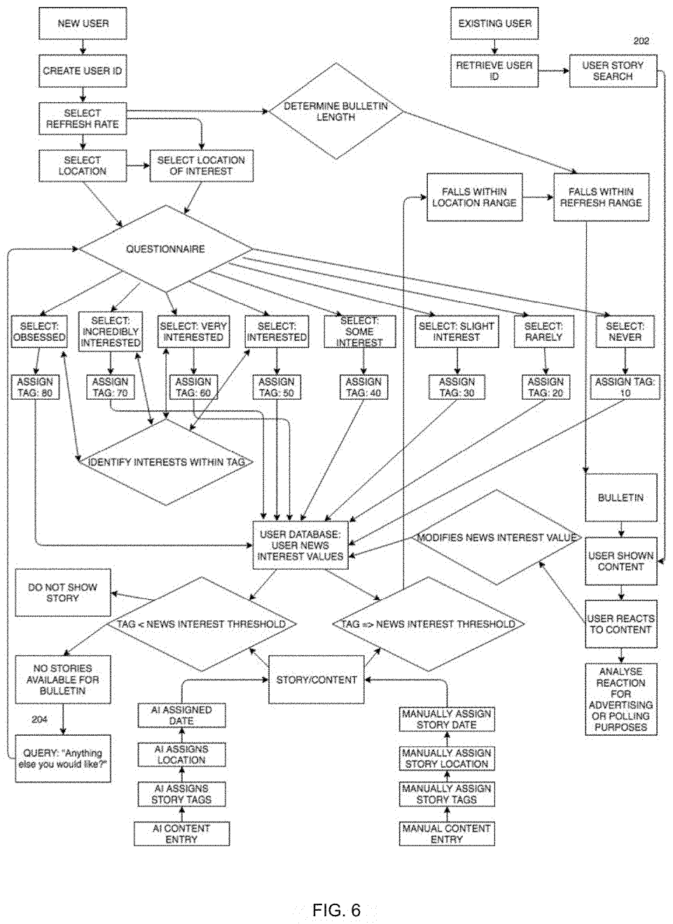

A questionnaire process, such as in FIG. 6 illustrated, may then determine the specific or particular interests within the specific news interest fields of Sports, Politics, Entertainment, Breaking News, Finance, Technology, Consumer and Finance. So, for instance, someone that indicates they are “extremely interested” in Politics may then be asked what type of Politics they are most interested in e.g. Federal Politics, State Politics etc. They may be further asked if they are particularly interested in a side of Politics e.g. Labor, Liberal, Greens etc. The interest fields are outlined in FIG. 5.

The values of interests may then be determined by their responses to the initial questionnaire process, as shown in FIG. 6. “Obsessed” assigns the value 80, “Extremely Interested” 70, “Very Interested” 60, “Interested” 50, “Some Interest” 40, “Slight Interest” 30, “Rarely” 20 and “Never” 10.

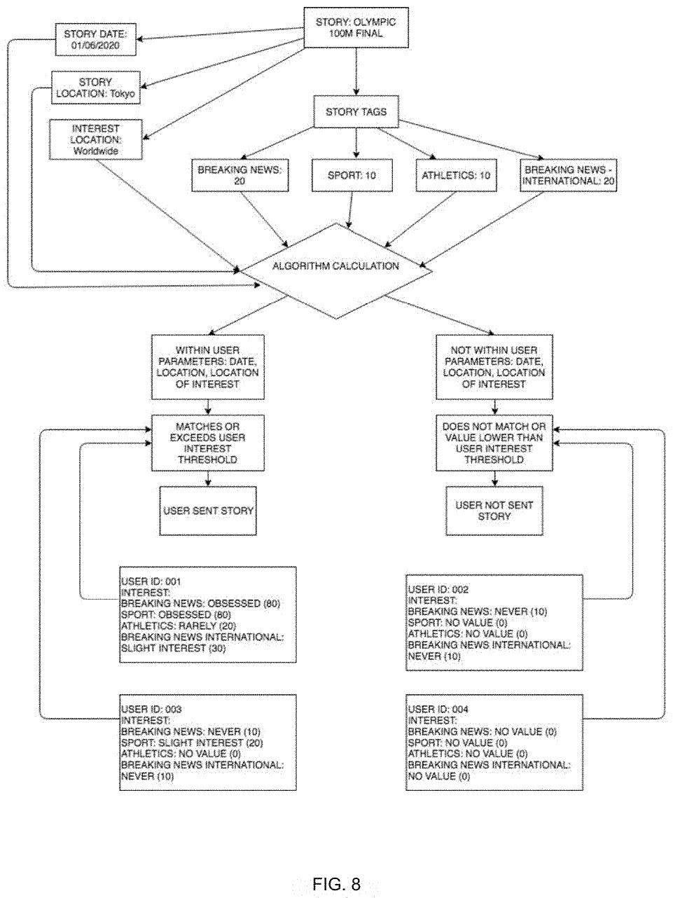

The user may then be shown stories corresponding to their interests. The stories may then be assigned tags corresponding to their interests through various methods. For example, this could be achieved by manual entry by a content provider, or, by artificial intelligence (AI) using speech recognition to identify the interests included within content or a story and assign relevant tags. The date and location of a story can also be entered by either manual or AI methods. Stories may be assigned news interest values on an opposing scale to user interests. The most important story in a particular category, may be assigned a high priority score of 0-10. A story with less significance, or with a very particular field of interest, may be assigned a lower priority score—for instance 80—and therefore meet the threshold for fewer users. The total range for values is from 0 to 100. 0 reserved for important stories such as 9/11, Lindt Cafe siege or a federal election result, while 100 may be for stories of little significance. For instance, as described in FIG. 8, a news story on the Olympic 100 Metre Final may be assigned the news interest values of Breaking News: 20, Sport: 10, Athletics: 10, Breaking News/subsection International: 20. This way, the story would be sent to virtually all users with an interest in sport and athletics. It may also be sent to users with a passing interest in Breaking News.

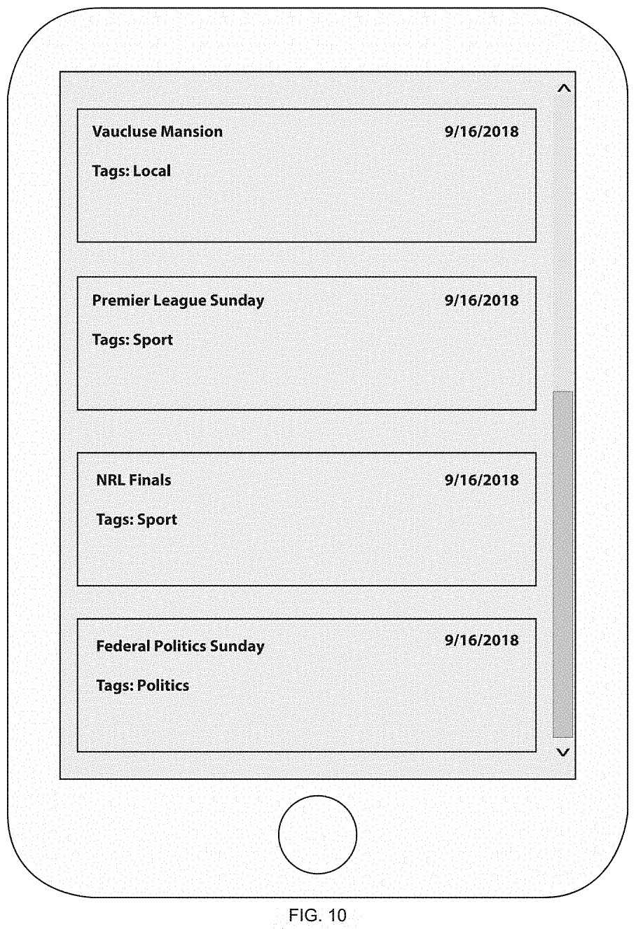

Only stories that have tags that match or exceed the news interest value of the user may be displayed in the bulletin, as shown in FIG. 10. A user only needs to have one field of interest match the tags of content or a story for it to be shown in the bulletin. The order of stories can either be from highest to lowest news interest value, most recent, or on a news interest weighting value to be decided by the content provider. In this method, the order of stories would usually be Breaking News, Crime, Politics, Finance, Sport, Technology, Consumer and then Entertainment.

Users may also be able to manually search for news content as shown in FIG. 6. If the user doesn't return enough matches for a bulletin, they can be asked “Anything else you would like?” as also shown in FIG. 6.

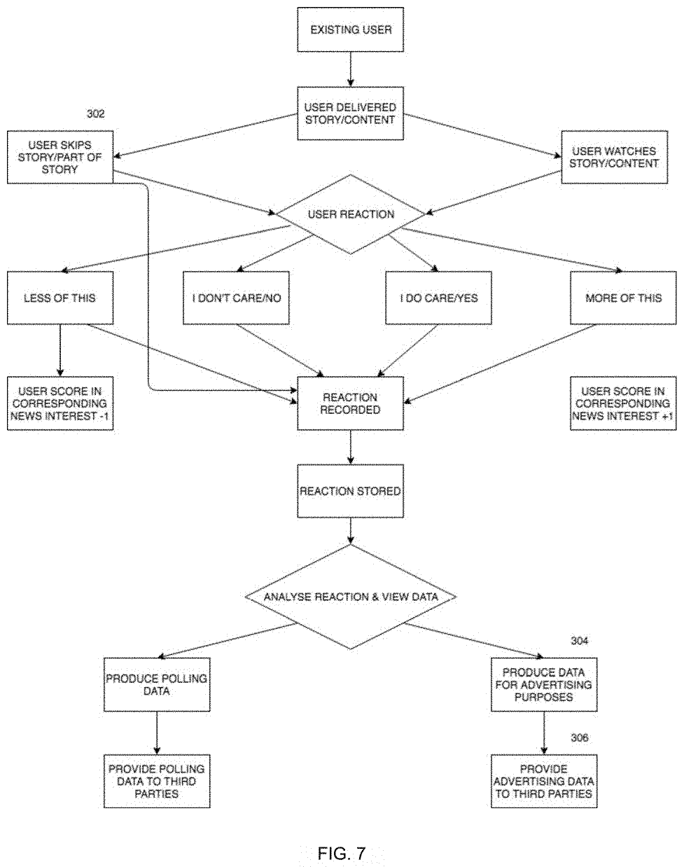

Users will have their viewing habits monitored and their news interest values modified as a result. As shown in FIG. 7, users may be able to react to a story in a number of intentional and unintentional ways. Watching content or stories from start to finish in a particular tag increases the field by a value of 1 as seen in FIG. 7. Skipping part or all of a story may cause the value to decrease by 1 as seen FIG. 7. This means the changing interests of users can reflected in the database values, and amend the stories they receive.

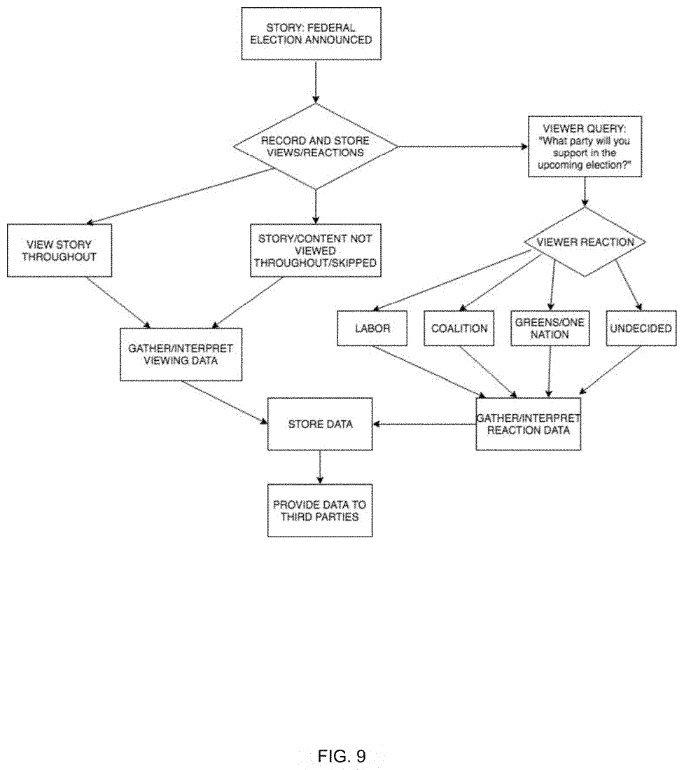

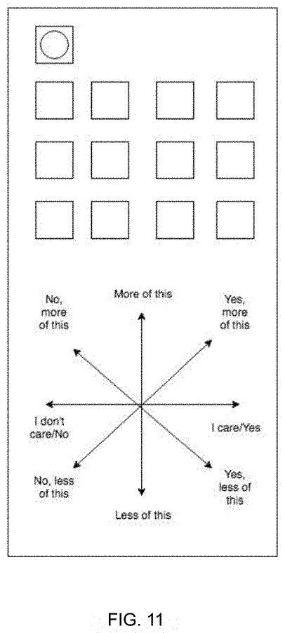

Users can also have the option to “React” to a story. On a Smartphone this may be achieved by swiping the screen. On a Smart TV App it is via the remote directional buttons as seen in FIG. 11. The reactions can change based on the story. But traditionally down means “Less of This” (value in particular tag reduced by 2), Up—“More of This” (value in particular tag increased by Two). Right reacts as “I Care” or “Yes, Important to Me”, Left—“I don't care” or “No, not important to me”. A combination of directions can return both “Reactions”. For instance, as seen in FIG. 9 with the story federal election launch a “Reaction” of left, diagonally down as represented on a clock as 7:30, would return a “Reaction” of “I want fewer stories on federal election”, and “No, I don't care about it”.

These “Reactions”, and view-throughs can then be used to create polling data or big data analysis of user views, interest, or lack thereof on a particular subject. This polling, or data analysis as seen in FIG. 9, can be provided to third parties to give insight into particular topics, products or news events.

A user's news interest values can also be used by the content provider to allow advertisers “one-on-one” marketing to users as seen in FIG. 7. For instance, a user with a news interest value of 80 in the field Consumer, subsection Luxury Car could be targeted for advertising by a Luxury Car business such as Mercedes.

FIG. 5 illustrates an exemplary database diagram which shows the plurality of categorisations of information items for the example which has been hereinbefore described, that is, relating to the provision of an information feed based on news items. It will of course be understood that a wide variety of other news items could additionally or alternatively be included. Person skilled in the art will also appreciated that a wide variety of other information items may be utilised which are not related to news bulletins and the like. As previously mentioned, this could include educational seminars, TV or radio programs, movies, or any other text audio or video information items which may be categorised and be of varying interest levels to individual users.

FIG. 6 illustrates a flow chart of how an algorithm utilised in the processor for the present invention may typically operate. As shown in the diagram, and new user might typically initially create a user ID, and then be provided with a plurality of questions in a questionnaire format, such that they can select their interest level associated with various topics. Each of these topics may then be assigned a tag or number indicative of the interest level of that particular new user. The flowchart in FIG. 6 also illustrates how other optional processes may be performed according to various algorithms to ultimately provide a score in relation to each topic, such that news items relevant to that topic can be ultimately chosen, to form part of the information feed provided to the user's device.

FIG. 7 illustrates a typical reaction diagram of a user when viewing an information item on their user device. The system may, for example, determine whether the user skips over some or all of the information, or, views the information item content more thoroughly. This automated user reaction may then be scored and/or recorded. If the user is monitored to watch the story, then the user profile may be updated such that the processor effectively determines that the user is interested in that particular type of story, and thereafter, the processor operates the algorithm such that more of that type story is provided in future to the user. FIG. 7 also illustrates how the user's reaction can be analysed to produce data for advertising purposes or polling purposes.

For example, if it is detected that a particular user likes to view news items in relation to fashion events, then data may be able to be provided to fashion advertising agencies to the user device.

Additionally or alternatively, the feedback ability of the user interface 7 of the user device 3 of the present invention could be utilised for survey or polling purposes. For example, in the advent of a political election, a survey could be sent to users such that they may be able to provide feedback scores in relation to the way they intend to vote in an election. In the processing of this survey information, rather than relying upon the user being surveyed having to indicate their political persuasion, the device may be able to automatically make a determination of this, based on the information items which they like to read.

FIG. 8 illustrates an example of an algorithm calculation for a particular user to determine whether or not a user is sent a particular information item or news story. The example in FIG. 8 is of a broadcast news item for an Olympic games sporting event, in particular, an Olympic Games 100 m final event. The upper section of FIG. 8 illustrates how the news item story may be categorised and incorporated into one or more categories. As an Olympic Games 100 m final event is considered to be generally important international breaking news, it may be categorised in the breaking news category and the breaking news international category as well as sports and athletics categories. The lower end of FIG. 8 illustrates how the processor might determine whether or not this particular information item might be within the desired parameters for a particular user to ultimately make the decision as to whether or not the user is sent the news story. FIG. 8 also illustrates how this determination may be typically calculated for four different users, each with varying level of interest

In FIG. 9 is illustrated in example of how a poll or survey may be conducted and analysed. The diagram illustrates an exemplary announcement of an Australian Federal Election. The system records and stores different user's reaction, to determine whether individual viewers view the story throughout or skip through the story. This data may be analysed and stored and provided to third parties. The right-hand side of FIG. 9 illustrates how viewer query may be sent as an information item 4, feedback by individual users to indicate how they may vote. This information may be correlated with viewer interest shown on the left-hand side of FIG. 9.

In FIG. 10, an example is illustrated of how an information feed, made up by a number of information items, may be displayed on a user's device 3. Once receiving information items in this format, the individual user may select items of interest, read the selected items of interest, and provide feedback accordingly. If users do not select the items of interest, this may be automatically monitored by the system and the user profile updated accordingly. For example, if the viewer consistently ignores sports items sent to them, then the level of interest in support of that particular user may be determined to be low, and therefore, the number of sports items issued to a user may thereafter be reduced.

### Hardware Components of System

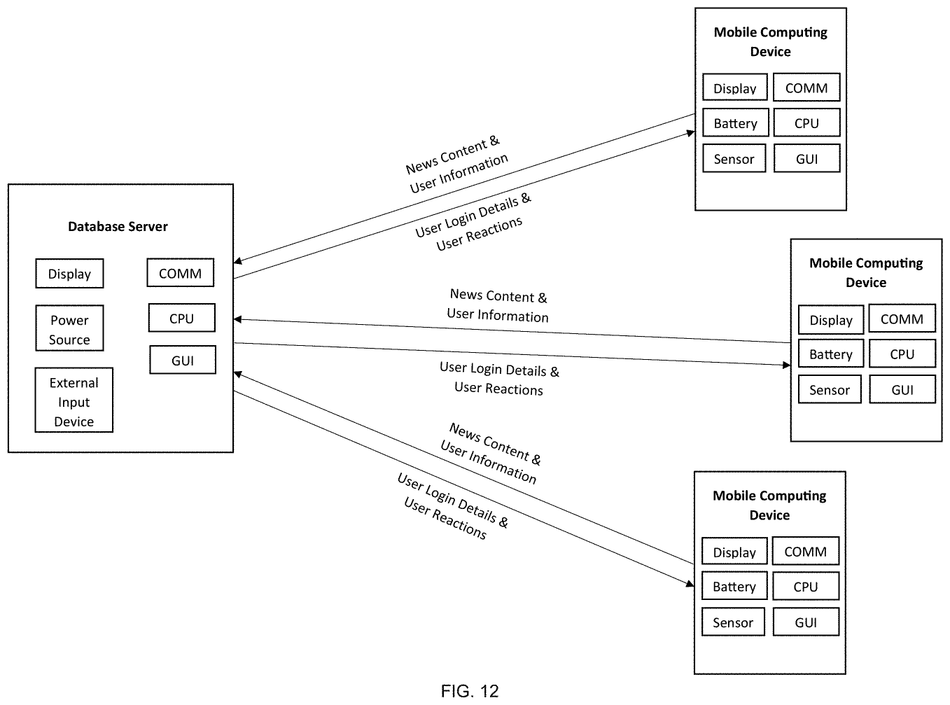

As shown in FIG. 12, the system may typically include a mobile computing device 1 that communicates with a server database 2 with the help of a news application installed on the mobile computing device 1.

In order for this operation, the mobile computing device 1 may preferably include a display 3, battery 4, sensor 5, conventional communication unit 6, processing unit 7, and graphical user interface 8. The mobile display screen 3 may be used to display the news content to the user, powered by the battery 4, and the touch sensor 5 may be used to record the user's input of the news content. This may be operated with the processing unit 7 and visually represented by a compatible graphical user interface 8, where the mobile communication device sends and receives data to the database server 2 using a conventional communication unit 6 which could be a wireless data connection such as Wi-Fi, Bluetooth or 4G cellular.

Similarly, the database server 2 may typically include a display 9, power source 10, a communication unit 11, processing unit 12, graphical user interface 13, and external input devices 14. The display screen 9 may help the content provider to monitor the health of the system, while the power source 10 may maintain consistent power to the server where the processing unit 12 manages and partitions the received user's data into the appropriate category. A communication unit 6 may send and receive data from the mobile computing device 1 with an appropriate graphical user interface 13 and external input devices, such as a mouse, microphone and/or keyboard, so that the content provide can assign tags, date and location to a news story either by manual entry or using artificial intelligence (AI) via speech recognition.

Within the database server 2, the server may comprise two databases that are linked by an algorithm to modify values of interest level on a scale from 0-100, known as the User Database and Content Database. The User Database will store the interest values for various topic fields of the individual user, where the user can modify the values in the database from his or her reactions. Topic fields could be in the form of tags such as but not limited to Sports, Politics, Entertainment, Breaking News, Finance, Technology, Consumer and Finance. Similarly, the Content Database will store interest values of news articles that are categorised with one or more topic fields, as well as their corresponding location and date, which are assigned by the content provider. The algorithm from the database server will determine whether the news article's parameters in the Content Database meets the criteria set by the User Database, and only send to the users that are interested in the news content.

For example, the content provider may set the important stories, such as a mass shooting or a federal election result, with a low score such as an interest level of 10 points for that topic field, such that the majority of users with a user interest level of 10 or more for that topic field, will receive the news content. In contrast, the content provider may restrict niche subject stories, with a high scoring of 80 for that topic field, so that only users with a topic field score of 80 or above will receive this news story, where the number of users will be significantly much less than the important news.

In operation, the mobile computing device 1 may send the user login details to the database server, where the database server authenticates and sends back the latest personalized news content for that specific user.

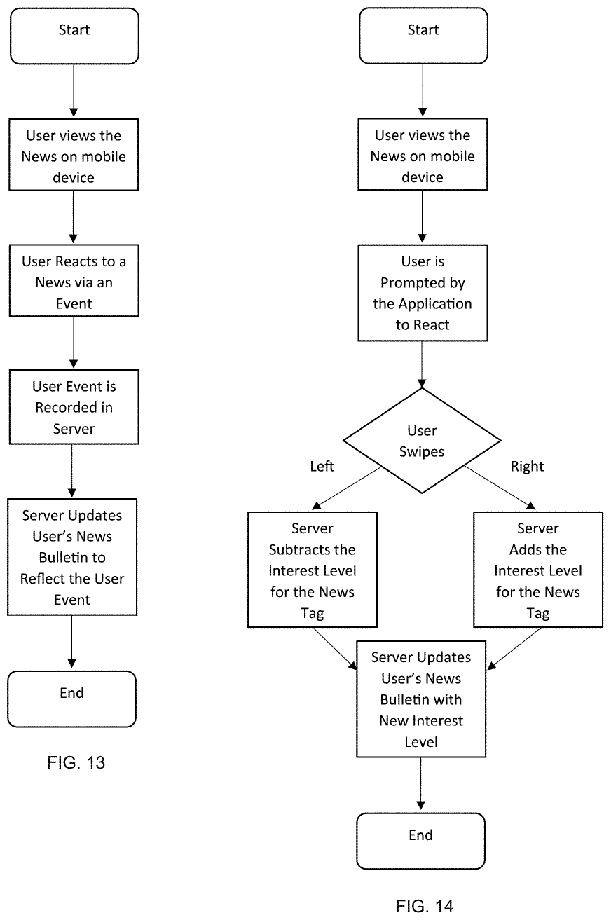

In FIG. 13, it is shown how the user may view the news content and react to the content by inputting an event on the mobile computing device wherein the mobile computing device will send the user event to the database server 2. The user event is recorded into the database server and the server may then update the user's interest level to the specific news topic based on the user's reaction to the content.

In one such embodiment, the user's event, shown in FIG. 14, is a simple swiping on the mobile computing device. The user may be asked if he or she enjoyed the news content after reaching the end of the news content. In an example which is not limited to, the user swipes left to show dissatisfaction of the news content while the user swipes right to show approval of the news content. The mobile computing device may then send the reaction to the database server, where the interest level will be decreased if the user swiped left, and increased if the user swiped right. The server updates the news bulletin data for that user and provide this updated news bulletin data to the user when he or she refreshes the news application.

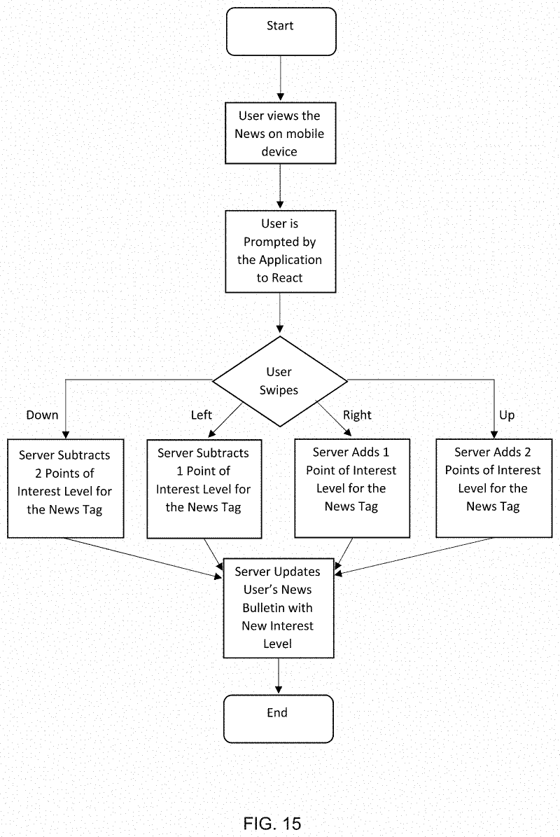

In a further embodiment, the swiping functionality could further produce a magnitude where for example but not limited to, the user could swipe down to express great dissatisfaction of the news content provided, such that the server will analyse this reaction to deduct two points of interest level from the specific topic, which is scaled from 0-100 points of interest. Similarly, swiping left will show a disapproval reaction, deducting one point of interest level, swiping right will show an approval reaction, adding one point of interest level, and swiping up will show a greatly approved reaction, increasing the interest level of the specific topic by two points, as depicted in FIG. 15.

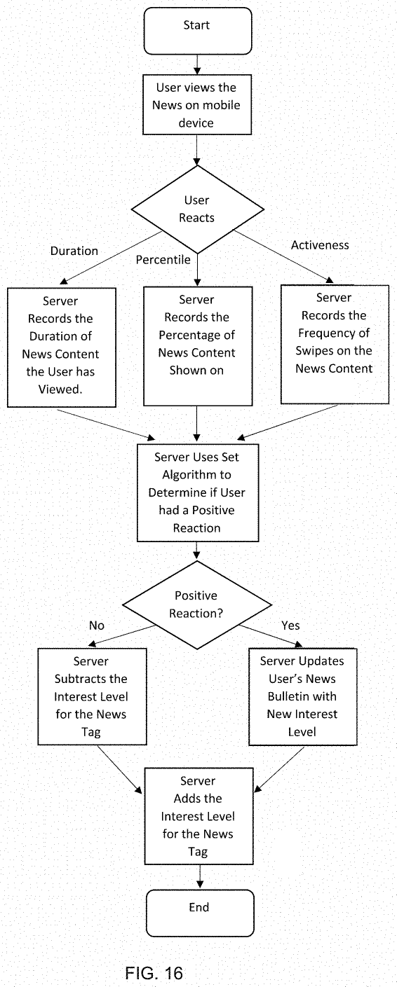

In another embodiment shown in FIG. 16, the event could be expressed by the activity of the user within the news content, the application could instruct the mobile computing device to send the duration that the user has stayed on the news content, the percentage of news content shown on the mobile computing device and the frequency of swipes on the news content, to the database server. The server database will perform a set algorithm to determine whether the user has a positive or negative experience with the news content and increment or decrement the interest level respectively to the specified topic tag. The server updates the news bulletin data for that user and provide this updated news bulletin data to the user when he or she refreshes the news application.

In another embodiment, the prompting of requesting a reaction and the recording of the user's activity could be combined to further improve the information collection of the user's interest habits.

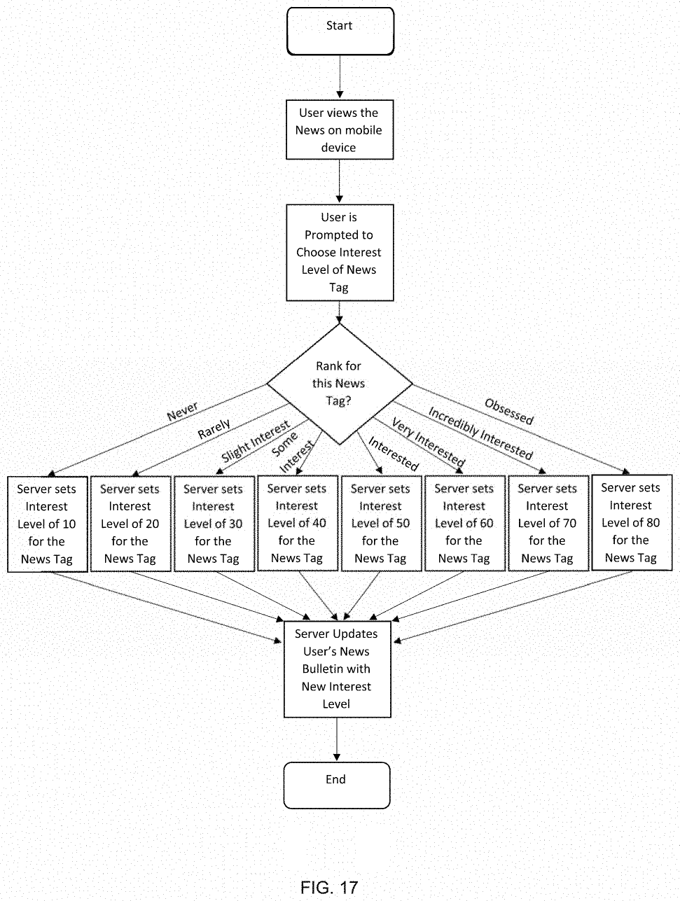

In another embodiment shown in FIG. 17, the user may initially set an interest level to the news tag by answering a questionnaire. The user is first prompted whether he or she is interested in the specific news topic in the form of a multiple choice of “Never”, “Rarely”, “Slight Interest”, “Some Interest”, “Interested”, “Very Interested”, “Incredibly Interested” and “Obsessed”, where the server will assign the interest level of 10, 20, 30, 40, 50, 60, 70 and 80 points. The lower the interest points, the less likely the news topic will appear on the user's news bulletin. The server updates the news bulletin data for that user and provide this updated news bulletin data to the user when he or she refreshes the news application.

The user reading habits can be further mapped by providing a sub topic field within the topic field. For Example, if users enjoys reading about Politics, the questionnaire will further ask what type of Politics they are most interested in e.g. Federal Politics, State Politics etc., and also to a further degree, what side of politics he or she represents e.g. left-wing, right-wing, central etc.

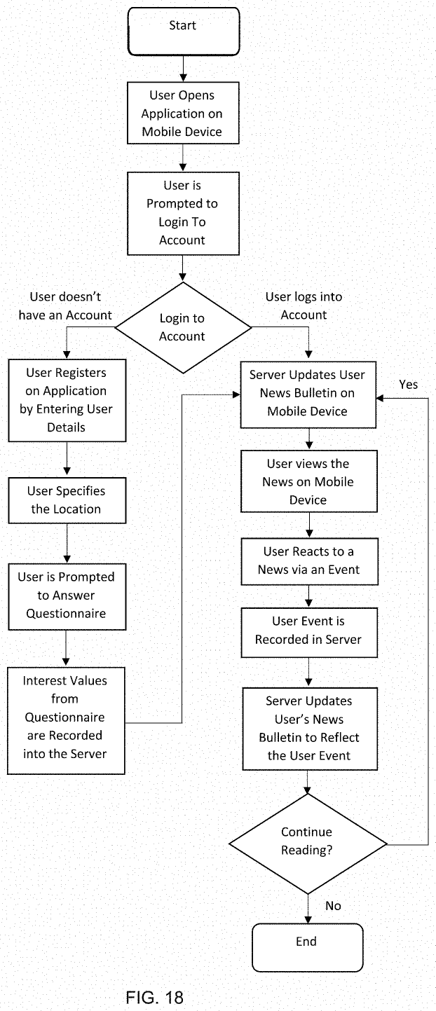

In another, method shown in FIG. 18, a new user may open the news application on the mobile computing device, where the user is prompted to login. If a new user does not have a login, the user is required to provide personal details to complete a standard registration and a unique password. The user may also be required to specify a location, wherein this location will help to provide relevant news within the specified location. However, this is not a restriction, as the user will have the ability to view news that he or she is interested in, which may not be part of his or her location. The user is then asked to answer a questionnaire, where the interest levels correlated to each news tag is recorded. The user is then able to access the news application content where he can enjoy reading or watching. The server will constantly receive user's reactions and fine tune the interest levels to properly represent the user. The server will prepare the newly updated news bulletin and when the user refreshes the application, the server will send this updated bulletin to the user's mobile computing device which reflect his or her reactions. This reaction process will be repeated until the user exits the mobile application.

It should be noted that this system does not restrict the user to certain topic fields. The user can manually search for news content within the application to explore different topic fields by accessing the application via the mobile computing device interface. The database server will also update the news interest levels to further reflect the user's reading habits.

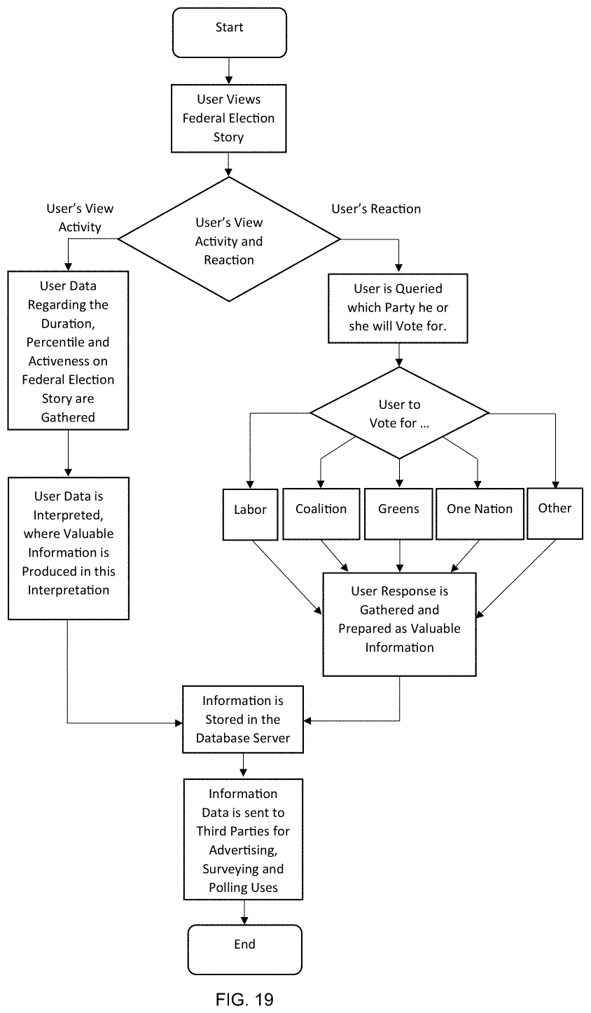

The monitoring and analysis system of the present invention may also beneficial to third parties as valuable information can be extracted from user's reading habits. As an example shown in FIG. 19, the application may directly and indirectly gather user viewing activity and reaction to an upcoming federal election news story. The user may view the news story and based on his response to this news content, this information could be collected to show the amount of interest to the upcoming federal election. For example, if the user glimpses the headline and skips the news content, this could potentially mean that the federal election does not potentially impact him or her as much. This can be quantitatively analysed by the duration, percentile and activeness reaction method shown in FIG. 16, which is more of an indirect approach.

For a more direct approach, the questionnaire multiple choice model could produce a set of questionnaires within the news content which may for example ask the user which party he or she will vote for. As this information will be kept private, the user will be comfortable in providing an honest answer to these queries.

This information will then be transferred to the third parties, where polling, surveying and advertising agencies will be able to receive this data in a presentable format with ease of use and information that is highly accurate, representing a large majority of the population in the region.

Whilst particular examples of the invention have been hereinbefore described to facilitate an understanding of the invention, it will be appreciated that a wide variety of alternate embodiments are capable of being implemented. All such variations and modifications which are apparent to a person skilled in the art, should be considered to fall within the scope of the invention as hereinafter claimed.

1. A system for delivering tailored information to a user based on an updatable user profile, the system including:
an information database, including a plurality of categorised information items;
a user device, including a user interface; and,
a processor, to:
generate an information feed, by selecting one or more information items from said information database, each information item being selected based on its categorised relevance to a user profile;
output said information feed to the user interface of said user device;
receive a user feedback score of each information item, via said user interface; and,
update said user profile based on said user feedback score(s).

2. A system as claimed in claim 1, wherein the information items includes news bulletins, advertisements, educational seminars, television or radio programs, movies or any other text, audio and/or video information items which may be categorised and be of varying interest levels to individual users.

3. A system as claimed in claim 1, wherein each information item is categorised into at least one category by a manual or automated process, optionally using machine learning or using artificial intelligence.

4. A system as claimed in claim 1, wherein each information item is categorised into at least one news category, including, but not limited to sports, politics, entertainment, breaking news, finance, technology, consumer, finance, crime, law & order, gossip, fashion, local news, international news, natural disasters, etc.

5. A system as claimed in claim 1, wherein the user device includes a smartphone, smart TV, computer, PDA or any other multimedia computing platform device.

6. A system as claimed in claim 1, wherein said user interface, includes any one or combination of a display screen, a touch screen, a keyboard, voice activated microphone, or any other interface device capable of receiving user input and output data.

7. A system as claimed in claim 1, wherein said user interface includes a user input interface device to provide a plurality of user selectable options including any one or combination of:
a numerical or like score selection buttons displayed on said user device, for example, to select a score of 1 to 10;
a drop down table of categories, for example, to select a user interest category; and,
a touch screen for a user to swipe in one of a plurality of directions, for example left, right, up and down indicative of a user interest level.

8. A system as claimed in claim 1, wherein said user interface includes a user monitoring interface device to detect a user interaction with the user device including any one or combination of:
a facial recognition device to detect the presence of a user looking at the user interface;
a timing device to detect how long a user has an information item displayed on said user interface; and,
a counting device to detect the number of times a user views a particular information item, a particular category of news items, etc. and,
a habit monitoring device to monitor the viewing habits of a user, including but not limited to the frequency of user interaction, the times of user interaction, the periods of user interaction, etc.

9. A system as claimed in claim 1, wherein said user profile is updated according to an algorithm or the like, based on any one or combination of:
a user feedback score provided by a user via said user interface; and,
a user feedback score calculated by the user monitoring device detecting the user interaction with the user device.

10. A method of delivering tailored information to a user based on an updatable user profile, the method including the steps of:
generating an information feed, by selecting one or more information items from an information database, each information item being selected based on its categorised relevance to a user profile;
outputting said information feed to a user interface of a user device;
receiving a user feedback score of each information item, via a user interface of said user device; and,
updating said user profile based on said user feedback score(s).

11. A method as claimed in claim 10, wherein the information items includes news bulletins, advertisements, educational seminars, television or radio programs, movies or any other text, audio and/or video information items which may be categorised and be of varying interest levels to individual users.

12. A method as claimed in claim 10, wherein each information item is categorised into at least one category by a manual or automated process, optionally using machine learning or using artificial intelligence.

13. A method as claimed in claim 10, wherein each information item is categorised into at least one news category, including, but not limited to sports, politics, entertainment, breaking news, finance, technology, consumer, finance, crime, law & order, gossip, fashion, local news, international news, natural disasters, etc.

14. A method as claimed in claim 10, wherein the user device includes a smartphone, smart TV, computer, PDA or any other multimedia computing platform device.

15. A method as claimed in claim 10, wherein said user interface, includes any one or combination of a display screen, a touch screen, a keyboard, voice activated microphone, or any other interface device capable of receiving user input and output data.

16. A method as claimed in claim 10, wherein said user interface includes a user input interface device to provide a plurality of user selectable options including any one or combination of:
a numerical or like score selection buttons displayed on said user device, for example, to select a score of 1 to 10;
a drop down table of categories, for example, to select a user interest category; and,
a touch screen for a user to swipe in one of a plurality of directions, for example left, right, up and down indicative of a user interest level.

17. A method as claimed in wherein said user interface includes a user monitoring interface device to detect a user interaction with the user device including any one or combination of:
a facial recognition device to detect the presence of a user looking at the user interface;
a timing device to detect how long a user has an information item displayed on said user interface; and,
a counting device to detect the number of times a user views a particular information item, a particular category of news items, etc. and,
a habit monitoring device to monitor the viewing habits of a user, including but not limited to the frequency of user interaction, the times of user interaction, the periods of user interaction, etc.

18. A method as claimed in claim 10, wherein said user profile is updated according to an algorithm or the like, based on any one or combination of:
a user feedback score provided by a user via said user interface; and,
a user feedback score calculated by the user monitoring device detecting the user interaction with the user device.

19. A user device for a user to receive selected information items from a plurality of categorised information items stored in an information database based on an updatable user profile of the user, the user device including:
a user output interface, for a user to receive each information item;
a user input interface, for a user to input a user feedback score for each said information item;
wherein, each said feedback score is communicated to a processor to update said user profile.

20. (canceled)

21. (canceled)

22. (canceled)

23. (canceled)

24. (canceled)

25. (canceled)

26. (canceled)
